(19) United States
(12) Patent Application Publication
(10) Pub. No.: US 2015/0172889 A1
(43) Pub. Date: Jun. 18, 2015

(54) WIRELESS NETWORK APPARATUS

(71) Applicant: THE UNIVERSITY OF TOKYO, Tokyo (JP)

(72) Inventor: Akihiro Nakao, Tokyo (JP)

(73) Assignee: THE UNIVERSITY OF TOKYO, Tokyo (JP)

(21) Appl. No.: 14/405,380

(22) PCT Filed: Jun. 4, 2013
(86) PCT No.: PCT/JP2013/065492

§ 371 Date: Dec. 3, 2014

(30) Foreign Application Priority Data
Jun. 4, 2012 (JP) 2012-127516

(51) Int. Cl. H04W 4/18; H04W 24/04; H04W 72/04; H04L 12/939

(52) U.S. Cl. CPC H04W 4/18; H04L 49/552; H04W 24/04; H04W 72/0446

(57) ABSTRACT

Provided is a wireless network apparatus capable of increasing the communication efficiency even when character string data, etc., is transmitted by including the data in a beacon frame. The transmission objective data is made redundant by a predetermined and divided into N data elements, the transmission objective data being reproducible on the basis of any arbitrary combination of m or more (m<N) data elements. The divided data elements are delivered as beacon signals.

### TECHNICAL FIELD

The present disclosure relates to a wireless network apparatus for, for example, predetermined IEEE 802.11 series wireless access points, etc.

### BACKGROUND ART

Recently, in the technology of predetermined IEEE 802.11 series wireless access points, transmitting a beacon frame with character string data or image data (referred to as original reproduction data) included in the beacon frame, has been considered. This technology has an advantage that, with the use of beacon frames, data transmission can be performed between a wireless access point and a wireless terminal, without authentication and connection processes.

However, the communication using beacon frames is one-to-multipoint communication, i.e., from an access point to wireless terminals, and thus, usual data frame retransmission process is not performed, and a retransmission request from the wireless terminal side cannot be performed. Accordingly, the following case may occur. Namely, among data packets α, β, and γ divided from the original reproduction data and transmitted from the access point, the data packet β cannot reach the terminal A and the character string data, etc., cannot be reproduced at the terminal A, the data packet α cannot reach the terminal B and the character string data, etc., cannot be reproduced at the terminal B, and all data packets can reach the terminal C and the character string data, etc., can be reproduced at the terminal C.

Therefore, the access point has to repeat sequential transmission of the frames including the data α, β, and γ to the application layer, regardless of whether or not the reception terminal has succeeded in the reception of the data. In this case, when the terminal A succeeds in the reception of the data packet β which has not reached the terminal A at the first transmission, the terminal A can reproduce the character string data. However, if the terminal B is still in lack of the data packet α, the terminal B cannot reproduce the character string data and has to wait for the next transmission of a from the access point. If the amount of original reproduction data increases, and along therewith, the number of pieces of the divided data increases, and further, the wireless propagation environment deteriorates, collecting all divided pieces of the frame which are not retransmitted but broadcasted, is difficult, leading to the worse communication efficiency.

Further, with respect to the wired network technology such as FTTH (Fiber To The Home), etc., Japanese Unexamined Patent Publication (Kokai) No. 2009-010530, etc., discloses an example of using FEC (Forward Error Correction) redundancy code in order to enable high-speed signal transmission.

### SUMMARY

In the above conventional technology, actually, the increase in the number of terminals to wirelessly communicate with the access point and the increase in the number of data packets lead to the increase in the number of combinations of data packets which cannot be received by each terminal. Accordingly, the simple retransmission control cannot be a realistic method for increasing the communication efficiency.

The present disclosure has been thought of, in view of the above drawbacks. One of the objects of the present disclosure is to provide a wireless network apparatus capable of increasing the communication efficiency even when the beacon frame is transmitted with character string data included therein.

A wireless network apparatus according to an embodiment of the present disclosure comprises a device which makes transmission objective data redundant by a predetermined method, and divides the redundant transmission objective data into N data elements, the transmission objective data being reproducible on the basis of any arbitrary combination of m(m<N) or more data elements, and a delivery device which delivers the divided data elements as beacon signals which can be received without any authentication or connection processes.

According to the present disclosure, communication efficiency can be increased even when a beacon frame is transmitted with character string data, etc., included therein, the beacon frame being a broadcast frame for which no retransmission process in the MAC (Media Access Control) is performed.

### BRIEF DESCRIPTION OF THE DRAWINGS

FIG. 1 is a schematic block diagram showing a constitution example of a system including a wireless network apparatus according to an embodiment of the present disclosure.

FIG. 2 is a flowchart showing an operation example of a wireless network apparatus according to an embodiment of the present disclosure.

FIG. 3 is an explanatory view showing an example of a content of a beacon signal to be transmitted by a wireless network apparatus according to an embodiment of the present disclosure.

FIG. 4 is an explanatory view showing an example of delivery of a data element to be transmitted by a wireless network apparatus according to an embodiment of the present disclosure.

### EMBODIMENT

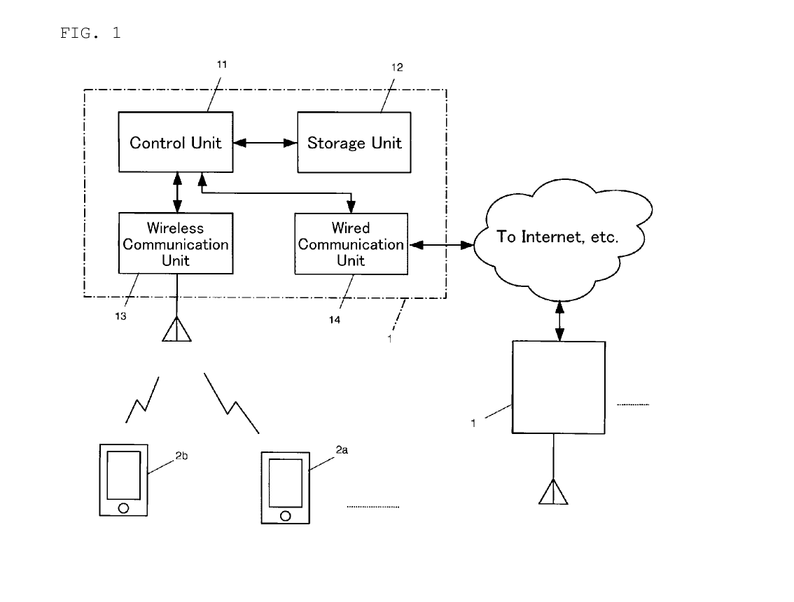

An embodiment of the present disclosure will be explained with reference to the drawings. As exemplified in FIG. 1, a system including a wireless network apparatus according to an embodiment of the present disclosure is constituted by comprising an access point 1 functioning as a wireless network apparatus, and terminals 2. A plurality of access points 1 may be provided. In general, a plurality of terminals 2 are located within an area in which data delivered by one access point 1 can be received.

The access point 1 is constituted by comprising a control unit 11, a storage unit 12, a wireless communication unit 13, and a wired communication unit 14. The control unit 11 is a program control device such as a CPU, etc., and operates in accordance with a program stored in the storage unit 12. Similar to an ordinary wireless LAN access point, the control unit 11 according to the present embodiment receives data transmitted from the terminal 2 trough the wireless communication unit 13. The control unit 11 directly outputs the received data to a predetermined address (router address) of the wired communication unit 14. Also, the control unit 11 transmits data destined to the terminal 2 and received through the wired communication unit 14, to the terminal 2 through the wireless communication unit 13.

Further, according to the present embodiment, unlike the ordinary wireless LAN access point, the control unit 11 performs broadcasting. Namely, the control unit 11 receives, through the wired communication unit 14, broadcast transmission objective data which is to be broadcast to a plurality of terminals 2. The control unit 11 makes this transmission objective data redundant by a predetermined method, and divides the data to N data elements, the data being reproducible by any arbitrary combination of m (m<N) data elements among the N data elements. Then, the control unit 11 commands the wireless communication unit 13 to deliver the divided N data elements as parts of beacon signals. The specific operations of the control unit 11 will be described below.

The storage unit 12 may be a memory device or a disk device. The storage unit 12 stores a program to be executed by the control unit 11. The program may be stored in a computer readable and non-transitory recording medium such as a DVD-ROM (Digital Versatile Disc Read Only Memory), etc., and copied to the storage unit 12. Further, in the present embodiment, the storage unit 12 also functions as a holding device which holds transmission objective data. In addition, the storage unit 12 also operates as a work memory of the control unit 11.

The wireless communication unit 13 is a wireless LAN interface which transmits/receives various types of data to/from the terminal 2 using a predetermined protocol such as 802.11n. In response to the commands input from the control unit 11, the wireless communication unit 13 sequentially broadcasts a plurality of data elements as beacon signals to a plurality of terminals 2.

The wired communication unit 14 is a wired LAN interface and is communicably connected to a server through an information communication line such as the Internet, etc. In response to the commands input from the control unit 11, the wired communication unit 14 transmits data commanded by the control unit 11 to a transmission destination addressed on the Internet. Also, the wired communication unit 14 outputs data received through the Internet to the control unit 11.

The terminal 2 is an information communication terminal such as a mobile phone, a smartphone, etc., which wirelessly transmits/receives data to/from the access point 1. According to the present embodiment, the terminal 1 transmits/receives data through the wireless LAN interface of the access point 1. However, the present embodiment is not limited thereto. For example, the terminal 2 may transmit data to an access point 1 which functions as a base station of a mobile phone communication network, using a mobile communication protocol such as IMT 2000, etc. Further, the data may be transmitted/received through a wireless WAN.

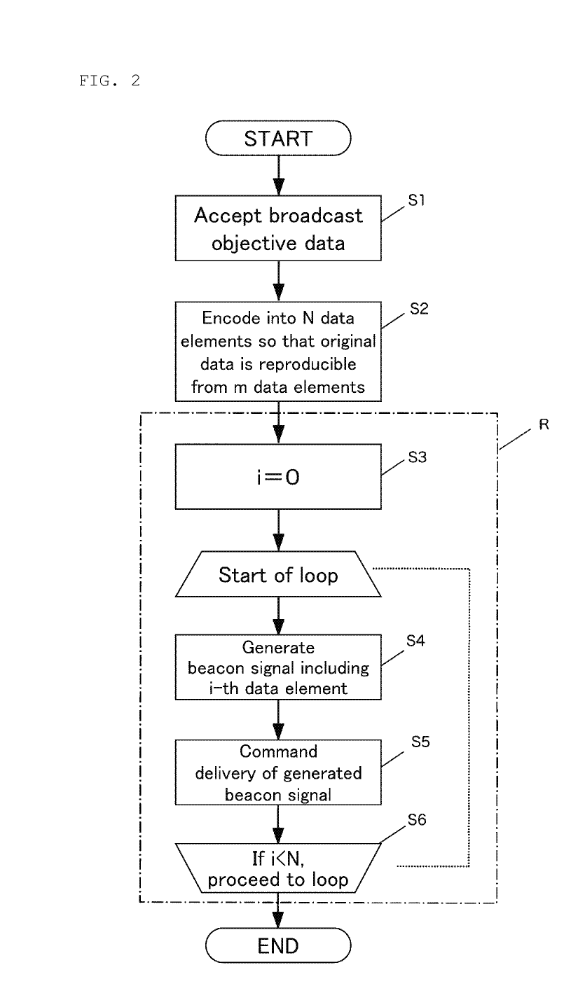

Next, the broadcast operation of the control unit 11 according to the present embodiment will be explained. As shown in FIG. 2, in accordance with the program stored in the storage unit 12, the control unit 11 according to the present embodiment externally receives, through the wired communication unit 14 (S1), data to be broadcast to a plurality of terminals 2, as a process of broadcast operations. The data may be commercial message information, etc., by HTML data which can be displayed by a web browser on the terminal 2 side.

The control unit 11 performs encoding by making the received data redundant using a predetermined method, and dividing the data to N data elements, the data being transmission objective data which is reproducible on the basis of any arbitrary combination of m (m<N) or more data elements (S2).

Such an encoding method may be a method using, for example, an erasure code, and various encoding methods such as various block encoding methods, may be applied. As an example, the method may comprise, providing a bit stream d0, d1, d2, d3, . . . , dn as transmission objective data, and calculating a linear combination sum regarding a plurality of combinations of bits contained in the bit stream.

Specifically, assuming that a bit stream including bits di is provided as the transmission objective data, a column vector having each bit di as an element, as shown in Mathematical Formula 1, is considered.

[Mathematical Formula 1]

\vec{d}=(d₁, . . . ,dₙ)^{T}(1)

In Mathematical Formula 1, T means transposition. Assuming that this transmission objective data is encoded, N(>n) pieces of encoded data are represented by ej (j=1, 2 . . . , N), and the column vector thereof is represented by Mathematical Formula 2.

[Mathematical Formula 2]

\vec{e}=(e₁, . . . ,e_{N})^{T} (2)

Thus, an example of the encoding method may be represented by Mathematical Formula 3 using a matrix G (the element thereof being gij (i=1, 2, . . . , N, j=1, 2, . . . , n)).

[Mathematical Formula 3]

\vec{e}=G·\vec{d} (3)

At this time, assume that n(<N) pieces of encoded data represented by Mathematical Formula 4 reach the terminal 2 side.

[Mathematical Formula 4]

\vec{e}′ (4)

The n(<N) pieces of encoded data are arbitrarily selected from the column vector represented by Mathematical Formula

[Mathematical Formula 2]

\vec{e}=(e₁, . . . ,e_{N})^{T} (2)

This can be represented by Mathematical Formula 5.

[Mathematical Formula 5]

\vec{e}′=K·\vec{e} (5)

In Mathematical Formula 5, the matrix K (the element thereof being kij (i=1, 2, . . . , n, j=1, 2, . . . , N)) refers to a matrix in which assuming that the encoded data ej reaches i-th in the order of time reaching the terminal 2, kij=1 is satisfied. Here, if Mathematical Formula 6 is satisfied, Mathematical Formula 7 is also satisfied.

$$\begin{matrix}[ Mathematical Formula 6 ] & \\ {G}^{′} = K \cdot G & ( 6 ) \\ [ Mathematical Formula 7 ] & \\ \begin{matrix}{\vec{e}}^{′} = K \cdot \vec{e} \\ = K \cdot G \cdot \vec{d} \\ = {G}^{′} \cdot \vec{d}\end{matrix} & ( 7 )\end{matrix}$$

Thus, if an inverse matrix of the matrix G′ is calculated, Mathematical Formula 8 is satisfied.

[Mathematical Formula 8]

\vec{d}=G′⁻¹·\vec{e}′ (8)

Therefore, the original data di may be obtained.

Here, G′ is a square matrix having a size n, in which n pieces of data selected from the N-piece row vector of G represented by Mathematical Formula 9, are arranged.

[Mathematical Formula 9]

\vec{g}ᵢ=(gᵢ₁, . . . ,gᵢₙ) (9)

In Mathematical Formula 9, i=1, 2, . . . , N.

Here, assume that G is constituted so that the n pieces of data arbitrarily selected from N pieces represented by Mathematical Formula 9, are independent from each other.

[Mathematical Formula 9]

\vec{g}ᵢ=(gᵢ₁, . . . ,gᵢₙ) (9)

In this case, G′ always has an inverse matrix, and thus, it may be understood that the n pieces of data di(i=1, 2, . . . , n) may be reconstituted by Mathematical Formula 4.

[Mathematical Formula ]

\vec{e} (4)

Such a matrix G may be a Vandermonde matrix as represented by Mathematical Formula 10.

$$\begin{matrix}[ Mathematical Formula 10 ] & \\ [ \begin{matrix}1 & {x}_{1} & {x}_{1}^{2} & … & {x}_{1}^{N - 1} \\ 1 & {x}_{2} & {x}_{2}^{2} & … & {x}_{2}^{N - 1} \\ 1 & {x}_{3} & {x}_{3}^{2} & … & {x}_{3}^{N - 1} \\ ⋮ & ⋮ & ⋮ & ⋱ & ⋮ \\ 1 & {x}_{n - 1} & {x}_{n - 1}^{2} & … & {x}_{n - 1}^{N - 1} \\ 1 & {x}_{n} & {x}_{n}^{2} & … & {x}_{n}^{N - 1}\end{matrix} ] & ( 10 )\end{matrix}$$

Namely, according an example of the present embodiment, the Vandermonde matrix G is multiplied by the column vector, the element of the column vector being each bit di in the bit stream of the transmission objective data, and thereby, the encoded data ej (j=1, 2, . . . , N) is obtained as data elements. Accordingly, as far as n data elements can be obtained, the length of n data elements corresponding to the length of the bit stream of the transmission objective data, the transmission objective data may be reproduced.

The control unit 11 initializes a variable i to “0” (S3), and generates a beacon signal frame provided with a bit stream representing the value of the (i+1)th data element, and information representing the number in the order of the encoded data elements from the start, of the (i+1)th data element (information regarding the variable i), in the frame of the beacon signal (S4).

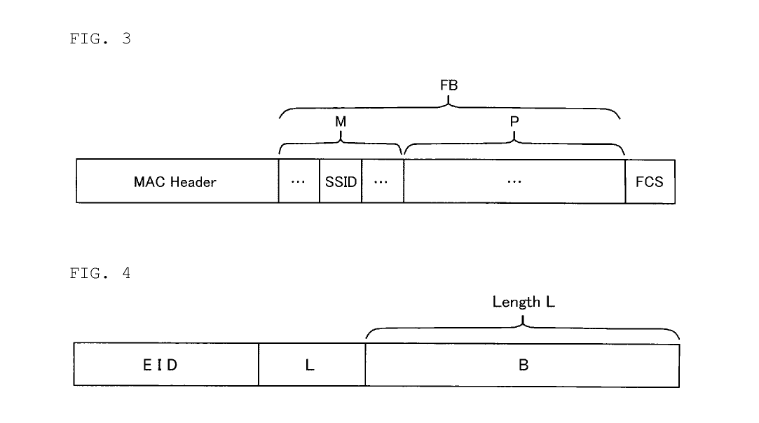

Specifically, as exemplified in FIG. 3, the beacon signal frame comprises a MAC header (MH), a frame body (FB), and an FCS (frame check sequence). Here, the FCS is a CRC-32 error detection code which is used for assessing whether or not the beacon signal frame has been received successfully.

The frame body of the beacon signal comprises an required portion (M) including the ssid (Service Set Identifier) assigned to the access point etc., and an optional portion (P). As exemplified in FIG. 4, the data contained in the optional portion (P) may be repetition of a data portion including an identifier (EID: Element ID) representing what the relevant data refers to, a data length (L: Length), and a data body (B). According to an example of the present embodiment, the control unit 11 generates a beacon signal frame with an data element included in the optional portion of the frame body. Specifically, the control unit 11 determines an identifier (predetermined) representing the content of data included in the data body, such as HTML data, image data, etc., as an EID, determines the length of the data element as a data length L, and determines to include each data element and a value of variable i in the data body B.

The control unit 11 may constitute the optional portion of the frame body as above, or as a Vender Specific IE (Information Element). The Vender Specific IE is predetermined in 802.11, and includes an Element ID, a data length (Length), an OUI (Organizationally Unique Identifier), and a data body. The Element ID is a code representing the content of the IE, and the OUI is an identification code of a vendor and is a unique value assigned by IEEE for the vendor. When this Vender Specific IE is used, the control unit 11 also determines to include each data element and a value of the variable i in the data body.

The control unit 11 commands the wireless communication unit 13 to deliver a beacon signal having a frame body generated as above (S5). The control unit 11 increments the variable i by “1”, and repeats the processes from Step S4 and thereafter, until the incremented variable i reaches the number N of the data elements (S6). When the incremented variable i reaches the number N of the data elements, the processes leave the loop and terminate.

The control unit 11 may repeat the processes (R) from Step S3 to Step S6 for predetermined times. Thereby, N data elements are repeatedly transmitted for a plurality of times.

According to an example of the present embodiment, a plurality of access points 1 which are located to be separated from each other are connected through a wired network, and each access point 1 performs the above processes. In this case, the data received by each access point 1 as transmission objective data may be the same data, and the encoding methods may be the same.

On the terminal 2 side, beacon information from any of the access points 1 may be selectively received. Then, the encoded data element itself, and information regarding the number in the order of the encoded data elements from the start, of the relevant data element, contained in the received beacon information, are extracted and stored in the memory (not shown) in the order of the receipt time from the earliest.

The terminal 2 does not have to receive all data elements from the first to the N-th, but continues the data reception from the access points 1 until the number of data elements reaches m (m<N) or more pieces. Assuming that the plurality of access points 1 deliver beacon signals including the same set of encoded data elements, the terminal 2 may obtain m data elements by receiving beacon signals from each of the plurality of access points 1. Namely, k data elements may be received from the first access point 1, and j data elements may be received from the second access point 1, resulting in the sum of k and j being m or more.

When m or more data elements are stored in the memory, the terminal 2 reproduces the transmission objective data from the values of the received data elements. Specifically, assuming that the encoding is performed using the Vandermonde matrix, the terminal 2 generates a column vector w (corresponding to the vector e′) in which the received data elements are arranged, in the order of the receipt time from the earliest, as elements of the column.

Also, the terminal 2 initializes a variable l as l=1, and reads out information r which represents the number in the order of the encoded data elements, of the data element which has been received l-th in the order of the reception time from the earliest (representing that the l-th received data element is the r-th data element in the order of the encoded data elements). Then, the terminal 2 determines kxy (x=1, 2, . . . , m, y=1, 2, . . . , N) so that klr=1 and klp(p≠r)=0 are satisfied.

Subsequently, the terminal 2 continues incrementing the variable l by 1 to determine values of kxy (x=1, 2, . . . , m, y=1, 2, . . . , N), and thereby a matrix K having the values of kxy as elements is obtained.

The terminal 2 multiplies the obtained matrix K, from the right, by the Vandermonde matrix G used by the access point 1 upon transmission, to obtain the matrix G′. As already mentioned above, the matrix G′ is an n-by-n square matrix since m=n is satisfied in the present example. Therefore, the matrix G′ always has the inverse matrix.

The terminal 2 obtains the inverse matrix of the matrix G′ by calculation, and multiplies the column vector w by the obtained inverse matrix G′⁻¹, to thereby reproduce the transmission objective data.

Accordingly, as far as the number of the data elements is m or more, the original broadcasted transmission objective data can be reproduced on the basis of any combination of the data elements. The terminal 2 treats the reproduced data as data obtained by estimate, and executes a predetermined process on the basis of this data.

For example, if the data obtained by estimate is HTML data, a process as a web browser is executed to understand the obtained HTML data and display the data on a display. In addition, this HTML data may include a command for the connection to a website on the Internet through the access point 1 through which the beacon signal has been received.

When this command is included, the terminal 2 refers to an ssid included in the received beacon signal, establishes a communication channel to the access point 1 using the ssid, and acquires data from the commanded website through the established communication channel.

A wireless network apparatus functioning as an access point 1 according to an embodiment of the present disclosure, and a terminal 2, are provided with above structures, and operate as follows.

The access point 1 according to the present embodiment divides data into N redundant data elements, and transmits the data elements in a way so that the data elements are respectively included in beacon signals. The data elements are generated so that, as far as arbitrarily selected m data elements out of N data elements are received, the original data can be reproduced. In the following explanation, as an example, N=32 and m=28 are satisfied.

Assuming that after the first delivery of N data elements from the access point 1, a terminal 2a receives 27 data elements excluding 1st, 5th, 16th, 20th, and 25th data elements, the terminal 2a has not received m or more data elements, and thus, the data cannot be reproduced. Assuming that another terminal 2b receives 25 data elements excluding 2nd, 12th, 13th, 14th, 17th, 21st, and 22nd data elements, the data cannot be reproduced at the terminal 2b, either.

The terminals 2a and 2b hold respectively received data elements. Next, when the second delivery of N data elements is performed from the access point 1, assuming that the terminal 2a receives 16th and 20th data elements from among the data elements which have not been received by the previous delivery, the terminal 2a obtains 29 data elements in total (1st, 5th, and 25th data elements are missing) taking into account the data elements which are held, which means that m or more data elements can be received. Therefore, the data can be reproduced, and the reproduced data can be subjected to processes such as displaying.

On the other hand, assuming that, unlike the terminal 2a, the terminal 2b cannot receive 16th and 20th data elements by the second delivery, but can receive 12th, 13th, 14th, and 17th data elements, the terminal 2b obtains 29 data elements in total (2nd, 21st, and 22nd data elements are missing) taking into account the data elements which are held, which means that m or more data elements can be received. Therefore, the data can be reproduced, and the reproduced data can be subjected to processes such as displaying.

Accordingly, even if the missing data elements are different among the terminals 2, or the data elements received by retransmission are different among the terminals 2, as far as the necessary number of data elements are received by each terminal 2, the combination of the received data elements does not matter. Thus, communication efficiency can be increased.

### MODIFIED EXAMPLE

Further, in the present embodiment, when the access point 1 retransmits the data elements, the transmission order may be made different. For example, 1st, 2nd, 3rd, . . . , data elements may be sequentially transmitted in this order in the first delivery, whereas the data elements may be transmitted in the different order such as 2nd, 4th, 6th, . . . , 1st, 3rd, 5th, . . . , in the second delivery.

1. A wireless network apparatus comprising:
a device which makes transmission objective data redundant by a predetermined method, and divides the redundant transmission objective data into N data elements, the transmission objective data being reproducible on the basis of any arbitrary combination of m(m<N) or more data elements, and
a delivery device which delivers the divided data elements as beacon signals.

2. The wireless network apparatus according to claim 1, wherein the delivery device delivers the divided data elements together with ssid as beacon signals.

3. The wireless network apparatus according to claim 1, wherein a plurality of delivery devices are arranged to be separated from each other.

4. (canceled)

5. The wireless network apparatus according to claim 2, wherein a plurality of delivery devices are arranged to be separated from each other.

6. The wireless network apparatus according to claim 1, wherein the delivery device repeatedly transmits the N data elements for a plurality of times.

7. The wireless network apparatus according to claim 2, wherein the delivery device repeatedly transmits the N data elements for a plurality of times.

8. The wireless network apparatus according to claim 3, wherein the delivery device repeatedly transmits the N data elements for a plurality of times.

9. The wireless network apparatus according to claim 5, wherein the delivery device repeatedly transmits the N data elements for a plurality of times.
